(19) United States
(12) Patent Application Publication
(10) Pub. No.: US 2016/0012508 A1
(43) Pub. Date: Jan. 14, 2016

(54) AmeriZone Select

(71) Applicants: Conrad Robert Blease, Wayne, PA (US); Andrew Paul Stankiewicz, Wayne, PA (US)

(72) Inventors: Conrad Robert Blease, Wayne, PA (US); Andrew Paul Stankiewicz, Wayne, PA (US)

(21) Appl. No.: 14/326,757

(22) Filed: Jul. 9, 2014

(51) Int. Cl. G06Q 30/06

(52) U.S. Cl. CPC G06Q 30/0625

(57) ABSTRACT

An internet based shopping method by which search results are presented in a prioritized listing focused on specific consumer interests. In the first embodiment search results are prioritized by American ownership and relation between the product and the American workforce. The highest tier of results contains products made in America from American owned companies, consideration is also given to foreign companies manufacturing in America, products assembled in America, companies owned by American based leadership, and companies with American stock holders. The system could be tailored to prioritize products from any one country or region. Results could also be given by excluding non-preferred countries of origin. Further breakdowns in additional embodiments allow shoppers to prioritize their search results and select their purchases by: Organic and Natural content, Locality, Fair Trade, Environmental Impact, Charity Support, Union Work Force, Length of Warranty, Cost of Ownership.

This application is a continuation of U.S. patent application Ser. No. 61/919,792, Dec. 22, 2013.

### TECHNICAL FIELD

The present invention relates to enhancing internet shopping based websites, more particularly, a system and method for easily compiling search results tailored to the specific desires of individual shoppers.

### BACKGROUND OF THE INVENTION

The internet is an ideal medium in which conduct commerce. The internet has given rise to websites which allow shoppers to see the inventory of the world and bring it to their doors with just a few clicks. In order to simplify online shopping the inventory offered by each website is typically displayed as a list either presented by the webpage or based upon a shopper's typed search terms. This list can then be further sorted. These sort options have evolved slowly and the more common options include: price—high to low, price—low to high, best selling, newest, customer review and relevance as some of the more common.

Today's shoppers can be very specific about their purchases. Individuals concerns about their products include: origin, composition, worker treatment, moral responsibility, environmental concerns and more. However, the search term driven results can be problematic and do not always produce the items desired by the potential purchaser. Potential purchasers then are forced to read through multiple reviews and detailed descriptions one by one, and often still do not find the specific information they desire to make an educated purchase or worse fall victim to unscrupulous, misleading, confusing or incomplete item descriptions.

The result-list sorting methods in existence offer little help to the potential purchaser in selecting the item of choice. The potential purchaser than is left with the choices of making no purchase at all, making an uninformed purchase, or settling for something other then what they wanted.

### SUMMARY OF THE INVENTION

The various embodiments of the present invention provide for a system and method by which to filter the results provided by an internet based commerce website.

A list of products or services available for purchase are presented as featured by the website or based on a Boolean search provided by the user. The present invention then allows for additional refinement options to be made available to the user. By accessing stored data about the individual products the individual refinement options filter the list and ranks products or services in accordance with the user's selection.

Refinement options include: Relationship of a product to a geographic region in terms of manufacturing and financial impact, the organic or natural content of a product, the distance of the product or products' manufacture to the end purchaser, the fair trade practices of the products' manufacture/seller, the environmental impact of the product or the products seller/manufacturer, the charitable donations made by the seller/manufacturer, the recycled content of a product, the union practices of the seller/manufacturer, the length of warranty included with purchase, the customer service practices of seller/manufacturer,

The results produced by select filters could be listed exclusively or intermixed with traditional results. The filters could be applied congruently with traditional filters.

### A DETAILED DESCRIPTION OF THE INVENTION

Amerizone Select is a business method. It is a method of organizing products that would be appended to a current online mega store or shopping portal. In the alternative Amerizone Select is the software necessary to append the Amerizone Select filters to an already existing online mega store or shopping portal.

The objective of the current invention is to make it possible and convenient for consumers to quickly and easily see the most relevant and personal shopping information. By filtering listings using an AmeriZone Select filter, consumers will be able to in a click see various aspects of where their products come from, what they contain, how they are made, and how the businesses behind them operate. If consumers would like their purchasing power to be used to favor an individual country, they will have access to the information necessary to do so. If consumers are concerned about the content of their food, health, and beauty products they can view the relevant information. If consumers are concerned about business practices they can seek out fair trade, union organized, and charitable minded companies. Purchasers can seek out local companies both to support the local economy and reduce shipping impact on cost and environment. Consumers can seek out products with a low environmental impact, like a high efficiency light bulb, or can seek out companies that manufacture using wind and solar energy and with limited environmental impact.

Amerizone Select filter methods can be applied along with each other, or along with traditional sorting and listing methods. The Amerizone family of filters allows one online-mega store to operate as an entire list of specialty shops.

The use of the Amerizone Select filters will benefit consumers, sellers and advertisers. Amerizone Select sorting will attract consumers to a shopping venue out of the desire to shop personally and responsibly. Select sorting will also attract sellers who want the beneficial or responsible features of their products highlighted. Further, select sorting will attract advertisers who can pinpoint their target audience with an additional degree of refinement and accuracy.

The necessary information to rank the Amerizone Select filter results will initially come from the distributors and manufactures of a good. Those that qualify for an Amerizone ranking should see the advantage of providing information. Further, the qualifications of a good or service will also be monitored by the public. Public participation is easy to collect from people wishing to promote the virtues of a product or preventing companies from falsely promoting non-qualifying products.

As an alternative to separate filtering and ranking the Amerizone Select filters could also be used to “tag” products produced under conventional post or search methods. As any product qualifying for the Amerizone Select filtering methods appears in a standard list, those products will be identified by a system of letters, symbols, and colors. For example a small American flag if a product is related to the USA economy, a green O for organic products, a green tree for nature zone products, or a red heart for the charity zone.

Once some or all of the filtering methods are in place the online mega-store could serve as an information portal for products not even necessarily sold. For example energy consumption and union practices may be listed about automobiles with sponsorship links out to qualifying manufactures. The American built, union built, highly efficient small car may be researched by the online consumer who could then follow a link out to make his or her purchase.

### Amerizone

In the first embodiment of Amerizone, shopping results are filtered by their relationship to a specific country. Consumers would have the option of viewing products by relation to a country through such factors as: made in a certain country, assembled in a certain country, or owned by a corporation or individuals within a certain country. Allowing consumers to use their purchasing power to support their own country is a primary intention of the AmeriZone internet shopping system. Selecting the Amerizone filtering would cause results to be listed from highest to lowest relationship to a specific country, by example America:

See the point system below by which: In the highest tier of Amerizone filtered results, the products listed are from a company that is entirely owned, based and manufacture their product in a specified country. For example, a company that produces goods in America and is also American owned.

In a lower tier of results, the products listed are from a company that is owned outside of America, but assembles their goods in America. For example, an auto maker that is owned in Asia, but assembles their cars in America using a large portion of imported parts.

In an additional and lower tier of results, the products listed are from a company that is owned by an American company but produces their products outside of the country. An example would be a California based computer and technology company that designs their products in America, but has them produced in China.

In the last tier of results, the products listed are from companies that have American stock holders. For example, a company that is owned outside of the country, produces their goods outside of the country but is available on a public exchange and has American shareholders who receive dividends or potential profit from the sale of stock

Amerizone filtering would be popular in other countries as well as 60% of Chinese consumers prefer American goods to Chinese goods. Also, as many European consumers also prefer their own countries' goods Amerizone easily becomes, Countryzone, Eurozone or Germanazone or Englazone and etc. to apply to other countries. Other possibilities include NAFTA-Zone or EU-Zone.

As an alternative, AmeriZone can also be used to eliminate one country of origin from the results page. This would allow consumers to exclude a country of manufacture from their search results. By example, search results could filter out, or adversely highlight products made in China.

The actual filtering and ranking could be performed simply by a point system where points are awarded by relationship to a countries' economy. Using the United States as an example, items completely manufactured in the United States are awarded 15 points. 7 points are awarded for a product that doesn't rise to the level of manufacture, but is assembled in America. An additional 5 points is awarded for American based ownership. An additional 1 point is added if the company has American Stockholders on a public exchange. Results then can be listed from highest combined score to lowest combined score.

### The Nature Zone:

In a second embodiment, search results of the online shopper are filtered by priority according to their Natural and Organic content. The products listed could be food, health and beauty goods, or manufactured goods, such as towels comprised of organic cotton and organic dies.

The first tier of results would be of products that our entirely organic. The second tier would be all natural with some organic components. The third tier would be products that are all natural. The fourth tier would be mostly natural products.

By Example:

Tier 1: Organic tea, or Towels made of Organic cotton and dyes.

Tier 2: Organic tea with non-organic all natural pomegranate flavoring.
Organic Cotton Towels with all natural dyes.

Tier 3: All Natural tea, or All Natural shampoo with no added chemicals.

Tier 4: All Natural tea with an artificial sweetener.
A mostly plant derived household cleaner.

Within each individual tier results could be filtered by percentages. In tier 2 A 95% organic tea would rank hire then a 85% organic tea. Likewise in tier 4 the higher the percentage of all natural products would rank one household cleaner over another.

### The Local Zone:

In a third embodiment, search results of the online shopper are filtered with priority given to products in the most proximity to the purchaser, or the delivery destination, or a shopper chosen zip code. This gives the shopper the opportunity to support local economy, enjoy local color, and reduce the environmental and financial impacts incurred with shipping.

Products would be sorted by measure of distance with the closest items given priority. Sample products could include produce, crafts, cheese, wine, furniture, or basically anything. A second sorting method could allow priority for local pickup or local shopping of the locally produced good.

### The Charity Zone:

In a fourth embodiment, products listed for sale are sorted in priority by their support of charitable causes. Highest priority would be given to those products which provide the highest percentage of their sales to charity. Future expansions of the charity zone could include pure charity items, which would be the sale of donated goods where 100% of the profits go to a specific charity. The charity zone could also be expanded to include ticket sales to charity events such as dinners, sporting events or entertainment.

Results in the charity zone would be filtered by the percentage of sales that go to promoting worthy causes. Examples include a toothpaste company that supports various charities and local causes or a water company that sells water and uses a percentage of profit to bring clean water into areas in need.

### The Fair Trade Zone:

In a fifth embodiment, priority listing would be given to products that are sold and produced under fair trade practices. Higher listing would be provided to certified products while secondary listing would be given to products that use their own certification system.

Typical fair trade products consist of coffees, teas, chocolates, wines, produce as well as crafts, cards, novelties and gift items.

Fair-trade International is an independent certifier. Also some specific coffee sellers use their own system to ensure fair practices. There are also chain stores that sell only fair trade crafts and goods collected from thousands of small villages around the world.

Ranking priority would go to official and independent fair trade certifications. Secondary ranking would go to self monitoring and self proclaimed producers of fair trade goods.

### Envirozone:

In a sixth embodiment, products are given priority based on their environmental impact. A search for light bulbs would reveal CFL and high efficiency lighting as the priority listed products. A search for a dish washer would reveal the most energy efficient dishwashers first. A search for other products could also be prioritized by the green practices of the manufacture. Priority listing would be provided to companies whose facilities utilize green electricity from wind or solar or who otherwise strive to minimize their carbon footprint.

A subset of Envirozone products is the Recycled Zone where products are listed by their recycled content. A high listed item would be 100% recycled paper towels or artificial gravel made from recycled tires. A qualifying, but low priority listing would be a product with 15% of the packaging being made of recycled materials. Priority listing could also be provided to products with compostable packaging.

The ranking of a product in the envirozone is more complex it is also one of the most important and worthwhile features of Amerizone.

To rank goods comprised of recycled materials preferred ranking would go to the highest content of recycled content. Paper towels made completely of recycled paper would rank highest, followed by paper towels made of 50% recycled paper, followed by paper towels packaged in recycled packaging.

An electric powered good would be ranked by terms of energy consumption. Appliances would be ranked by efficiency, highest to lowest; the same method applies to light bulbs, computers and many consumer goods.

Goods can also be ranked by their ability to be recycled or composted.

### The Union Zone

The Union Zone is a more specific and typically a yes or no filtering method. Products manufactured by a unionized workforce receive higher ranking. Additional ranking may be provided to those institutions which provide well for their work staff in terms of healthcare, continuing education, retirement, profit sharing and retirement.

### The Warranty Zone

The Warranty zone prioritizes listing by the length of a products warranty. By example a computer or phone with a longer warranty would be listed higher. Thus insuring the consumer his purchase will satisfy his or needs for a guaranteed length of time. An automobile with a 100,000 mileage warranty would outrank one with only 60,000 miles of warranty. A full warranty of equal miles would out rank a drive train only warranty. A computer with a three year warranty outranking a computer having a warranty of shorter time duration.

### Support Zone

The support zone ranks goods by the customer support offered. Many consumers buying complex goods, or goods of a new technology would prefer and even need better customer support. Preferred ranking (for American shoppers) would go to those goods offering call centers located within the United States. Other ranking could be based on customer feedback about the customer support they received.

### SUMMARY

Consumers are demanding more and more options and specialization in their purchasing. This system responds to that need and allows anyone to be quickly informed and buy according to their resolve. By fine tuning their search results when online shopping, consumers can use their purchasing power more safely, more responsibly and more enjoyably. The AmeriZone select method would help focus and target shopping for a global market. It can be used by virtually any search engine and shopping website to promote the causes important to purchasers and suppliers, and at the same time increase sales and advertising revenue. The Amerizone family of filters allows one online-mega store to operate as an entire list of specialty shops.

The long term effects could be profound. Other online sellers and even brick and mortar sellers would follow suit in providing consumers with the information they crave. Products of responsible manufacture will receive an instant bump in sales as their products are featured and highlighted. Eventually, savvy manufactures will respond to the demands of information empowered consumers; sellers will be pleased or even forced to provide goods satisfying the needs and wants of consumers with desires to support their own economy, protect their own environment, and shop more responsibly in regards to their own priorities.

We claim:

1. A method for improving current online shopping models which comprises:
the additional filtering and listing of product results generated by an online seller or online shopping portal,
by request of the consumer or being featured by the online seller,
such information necessary to prioritize results as provided by the product's manufacturer, the product's distributor, or the public,
whereby products are filtered and listed by priority in relationship to one or more specialized features.

2. The method of claim 1 wherein the additional filtering and listing of products is generated by the products relationship to a country of choice,
the results being prioritized first by the country of manufacture,
second by the country of assembly,
third by the country hosting ownership,
fourth by the country hosting public ownership of the company on a public exchange,
Products being listed based on total points accumulated with 15 points being awarded for manufacture in the country of choice, 7 points being awarded assembly in the country of choice, 5 points being awarded for ownership in the country of choice, 1 point being awarded for being featured on a public exchange in the country of choice.

3. The method of claim 1 wherein the additional filtering and listing of products either eliminates or negatively highlights products manufactured or assembled in a country of choice.

4. The method of claim 1 wherein the additional filtering and listing of products is generated by the organic and natural content of the product,
the results first being prioritized by the percentage of the products organic content,
the results second being prioritized by the percentage of their all natural content.

5. The method of claim 1 wherein the additional filtering and listing of products is generated by the distance of the products location or manufacture from the consumer,
the results being filtered by the travel distance of the product, as available for shipping, or pick up, from the consumer,
in the alternative, or in conjunction, the distance of cite of manufacture of the good from the consumer.

6. The method of claim 1 wherein the additional filtering and listing of products is generated by the portion of that product's proceeds which goes to support a charitable cause,
the results being ranked by the percentage of proceeds going to a charitable cause from highest to lowest.

7. The method of claim 1 wherein the additional filtering and listing of products is generated by the fair trade practices of the goods manufacturer,
the results being prioritized first by products which meet the guide lines and qualifications of independent fair trade certifications,
the results being prioritized second by products which meet the guidelines of their own independent or self proclaimed fair trade practices.

8. The method of claim 1 wherein the additional filtering and listing of products is generated by the environmental impact of the product,
the results of appliances and powered goods being ranked by their efficiency from best to worst,
the results of textiles, fixed goods, and consumable goods ranked by their recycled content,
the results of goods ranked by their ability to be recycled, composted or reused,
the results of products being listed by the environmental practices of their company of manufacture,
the specific ranking method or methods used being those most applicable to the products resulting from a conventional search or initial product list.

9. The method of claim 1 wherein the additional filtering and listing of products is generated by the product's manufacturer's use of a unionized or non-unionized work force.

10. The method of claim 1 wherein the additional filtering and listing of products is generated first by the duration of a products warranty and second by the comprehensive nature of said warranty.

11. The method of claim 1 wherein the additional filtering and listing of products is generated by the products relationship to the customer support offered,
first by the location of the call center being the same as the country of the consumer
second by the consumer given ranking of the customer support offered.

12. A tagging system by which products in a conventional list are highlighted by the addition of a conspicuous color, letter or symbol
such tagging being automatically provided or provided in one or more category by request of online shopper,
such tagging that notifies the consumer of that products qualification into predetermined categories,
such information necessary to tag results as provided by the product's manufacturer or distributor, or the public.

13. The method of claim 12 wherein the additional tagging of products is generated by the product's relationship to a country of choice,
a product being tagged with a small flag to indicate the product's country of origin.

14. The method of claim 12 wherein the additional tagging of products includes a large red X to indicate a non-preferred country of product's origin.

15. The method of claim 12 wherein the additional tagging of products is generated by the organic and natural content of the product,
an entirely organic product having its listing marked by the official organic logo of the presiding authority,
an entirely natural product being marked by a green N.

16. The method of claim 12 wherein the additional tagging of products
is generated by the distance of the products location or manufacture from the consumer,
The results being tagged with the a numerical representation of the products distance in mileage if so applicable

17. The method of claim 12 wherein the additional tagging of products is generated by charitable donations of a good's manufacture, or distributor, products which the purchase of generates a charitable donation being marked with a red heart.

18. The method of claim 12 wherein the additional filtering and listing of products is generated by the fair trade practices of the good's manufacturer, the results being tagged first which meet the guide lines and qualifications of independent fair trade certifications, being tagged with such marking as provided by the governing body the results being tagged second by products which meet the guidelines of their own independent or self-proclaimed fair trade practices being tagged with identifying marks corresponding to the language used by the products manufacturer or distributor

19. The method of claim 12 wherein the tagging of products is generated by the environmental impact of the product, a small globe being used to tag:
high efficiency appliances and high efficiency powered goods,
as well as textiles, fixed goods, and consumable goods ranked containing recycled content,
as well as goods designed or packaged to be recycled, composted or reused,
as well products of manufacturers with a commitment to green and sustainable practices.

20. The method of claim 12 wherein the tagging of products is generated by the product's manufacture's use of a unionized or non-unionized work force, products being manufactured by a unionized work force being tagged with an upper case blue U.

21. The method of claim 12 wherein the additional filtering and listing of products is generated first by the duration of a product's warranty and second by the comprehensive nature of said warranty.

22. The method of claim 1 wherein the additional filtering and listing of products is generated by the products relationship to the customer support offered, first by the location of the call center being the same as the country of the consumer,
second by the consumer given ranking of the customer support offered.

23. Such software and or coding as would be obvious to one of standard skill in the art necessary to augment an existing online mega store or shopping portal in order to display and actualize:
the additional filtering and listing of product results generated by an online seller or online shopping portal,
by request of the consumer or being featured by the online seller,
such information necessary to prioritize results as provided by the product's manufacturer, the product's distributor, or the public,
whereby products are filtered and listed by priority in relationship to one or more specialized features,
or by which products in a conventional list are highlighted by a conspicuous color, letter or symbol.
